(19) United States
(12) Patent Application Publication
(10) Pub. No.: US 2012/0127736 A1
(43) Pub. Date: May 24, 2012

(54) Lighting Device and Method for Producing a Lighting Device

(76) Inventors: Guenter Hoetzl, Regensburg (DE); Thomas Preuschl, Sinzing (DE); Peter Sachsenweger, Zeitlarn (DE)

(21) Appl. No.: 13/388,276

(22) PCT Filed: Jul. 13, 2010
(86) PCT No.: PCT/EP2010/060016

§ 371 Date: Jan. 31, 2012

(30) Foreign Application Priority Data
Jul. 31, 2009 (DE) 10 2009 035 515.4

(51) Int. Cl. F21V 15/01; F21V 21/08; F21V 19/00; F21V 21/00

(52) U.S. Cl. 362/365; 362/382; 362/396; 29/428

(57) ABSTRACT

A lighting device (1; 50; 60; 70; 80; 100; 100b) comprising: a body (4), particularly a heat sink, having an outer contact surface (24); and a light source carrier (6; 32; 61; 71; 81) pressed onto the contact surface by at least one pressing element (43; 51; 101), wherein the pressing element is adapted to be attached to the lighting device by at least one rotary motion.

The invention relates to a lighting device, in particular an LED retrofit lamp or an LED module for a retrofit lamp. The invention also relates to a method for producing a lighting device.

LED retrofit lamps and their light sources are typically operated using a safety extra low voltage (SELV). For this purpose, the LED retrofit lamp comprises a driver for operating the LED(s) which includes a voltage regulator for converting a mains voltage, for example of 230 V, to a voltage of approximately 10 V to 25 V, typically a transformer. The efficiency of a SELV driver is typically between 70% and 80%. In SELV devices, insulation distances of at least 5 mm between a primary side and a secondary side in relation to the voltage regulator have to be maintained for the protection of a consumer so as to prevent the user from receiving an electric shock caused by leakage currents. In particular, surge pulses of up to 4 KV originating from a mains supply should be kept away from the secondary side so that there is also no risk to the user if he touches live, accessible parts such as the heat sink during the occurrence of the surge. The LED lamp must also meet specific flame retardance ratings, which was previously only achieved by materials having a high flame retardance rating or by use of metal joining elements.

For example, LED retrofit lamps may be designed so that the LED(s) is/are mounted on a carrier which is screwed to the heat sink and is electrically insulated therefrom. A necessary length of the leakage path or insulation between potential-carrying or electrically conductive surface areas (contact fields, line tracks, etc., for example on copper and/or conductive paste with silver for example) and the heat sink is achieved by firstly observing a distance of at least 5 mm between the potential-carrying surface areas and an edge of the carrier, and by secondly observing an electrically insulating area of at least 5 mm around the screwing points. However, such a design has a large surface area requirement.

The object of the present invention is to provide a particularly simple and precisely mountable and cost-effective lighting device, in particular an LED retrofit lamp.

This object is achieved by means of a lighting device and a method according to the respective independent claim. Preferred embodiments can be derived in particular from the dependent claims.

The object is achieved by means of a lighting device, wherein the lighting device comprises at least one body having a contact surface and also a light source carrier, wherein the light source carrier is pressed by means of at least one pressing element onto the contact surface, wherein the pressing element can be attached to the lighting device by means of at least one rotary motion (“twisting/pressing element”).

The lighting device affords the advantage that the light source carrier can be attached by a simple rotational motion. Furthermore, this attachment operation can be carried out quickly and, for example, does not have to set, in contrast to an adhesive connection. The pressing element may also be fed simply in a linear manner. Furthermore, the feed of the pressing element and the process of rotation can be automated. It is a further advantage that the rotary connection makes it possible to precisely adjust a pressing force over the degree of rotation, for the example the angle of rotation. Damage or deformation of the light source carrier and further pressed parts can thus be avoided, and at the same time the pressing force can be sufficiently high for effective thermal transfer to the body. The adjustment of the pressing force also allows a tolerance compensation with regard to an installation height of the carrier. Furthermore, the flame retardance ratings can also be retained, even without use of metal joining materials or relatively expensive materials having a high flame retardance rating.

In particular, the body may be a heat sink. The heat sink may advantageously consist of an effective heat-conducting material with λ>10 W/(m·K), more preferably λ>100 W/(m·K), in particular of a metal such as aluminium, copper or an alloy thereof. The heat sink may also consist completely or in part of a plastics material, however; an effective heat-conducting and electrically insulating plastics material is particularly advantageous for electrical insulation and extension of the leakage paths, however the use of an effective heat-conducting and electrically conductive plastics material is also possible. The heat sink may be substantially symmetrical, in particular substantially rotationally symmetrical, for example about a longitudinal axis. The heat sink may comprise heat dissipation elements, for example cooling ribs or cooling pins.

The light source carrier may comprise one or more light sources. The type of light sources is not limited for the time being. However, it is preferable for operation with low power loss and particularly compact construction if the light source is a semiconductor source, for example a laser diode or a light-emitting diode (LED).

The semiconductor light source may comprise one or more emitters. The semiconductor emitter(s) may be applied to the carrier, on which further electronic components such as resistors, capacitors, logical units, etc. can be mounted. For example, the semiconductor emitters may be applied to the carrier by means of conventional soldering methods. However, the semiconductor emitters may also be connected to a substrate (submount) by chip-level connection types, such as bonding (wire bonding, flip-chip bonding), etc., for example by fitting a substrate made of AlN with LED chips. One or more submounts may also be mounted on a printed circuit board. With the presence of a plurality of semiconductor emitters, these may irradiate in the same colour, for example white, which allows simple scalability of brightness. However, the semiconductor emitters may also have a different beam colour, at least in part, for example red (R), green (G), blue (B), amber (A), mint (M) and/or white (W), etc. A beam colour of the light source can thus optionally be varied, and any colour point can be set. In particular it is preferable if semiconductor emitters of different beam colour can produce a white mixed light. Organic LEDs (OLEDs) can also generally be used, either instead of or in addition to inorganic LEDs, for example based on InGaN or AlInGaP.

The carrier may be designed as a printed circuit board or another substrate, for example as a compact ceramic body. The carrier may have one or more wiring layers.

It may be advantageous, for the uniform distribution of a plurality of light sources, in particular LEDs, with a simultaneously simple design of the leakage paths whilst observing predefined insulation paths, if the carrier is arranged peripherally and concentrically or coaxially with an upwardly protruding cable duct. A low lateral extension of the carrier relative to a longitudinal axis of the heat sink is thus also achieved. It may be advantageous, in order to observe predefined insulation paths, if the light sources are arranged substantially uniformly in the peripheral direction.

The carrier may advantageously be attached to the heat sink by means of an electrically insulating interface layer. The electrically insulating interface layer may advantageously be adhesive on both sides for a reliable connection between the carrier and heat sink. For example, the interface layer may be a thermal interface material (TIM), such as a heat-conductive paste (for example silicone oil with additives of aluminium oxide, zinc oxide, boron nitride or silver powder), a film or a pad or a mat. Alternatively, a silicone layer or the like may be used, for example. The interface layer may also afford the advantages of a high dielectric strength and an extension of the leakage path.

The carrier may generally comprise at least one electrically insulating insulation layer. An insulation layer may particularly advantageously consist of a material which is a good thermal conductor and a poor electrical conductor, at least in the direction of thickness. An insulation layer made of ceramics, such as Al₂O₃, AlN, BN or SiC is particularly advantageous. The insulation layer may be formed as a multi-layered ceramics carrier, for example using LTCC technology. For example, layers comprising different materials may also be used, for example those comprising different ceramics. For example, these may be formed so as to be highly dielectric and poorly dielectric in an alternating manner. The at least one insulation layer may also consist of a typical base material for a printed circuit board, such as FR4, which is less advantageous from a thermal point of view but very cost effective. The carrier may advantageously have a dielectric strength of at least 4 KV so that surge pulses, at least of this magnitude, do not penetrate the carrier.

To achieve a particularly advantageous compromise between maximisation of the insulation path and minimisation of the thermal path between light source(s) and heat sink, a thickness of the carrier may advantageously lie in a range between 0.16 mm and 1 mm.

The rotary motion may be carried out by means of the pressing element itself or by means of an element which is attached rotatably to the pressing element (“pressing counter-element), for example similarly to a pair formed of a screw and a nut.

To avoid a shortening of leakage paths, the pressing element may consist of a non-conductive material, in particular a plastics material, or may comprise such a material as a base material.

In one embodiment the pressing element has at least one screw thread for attachment to the body (“screwing/pressing element”). The rotary motion is a screwing motion in this case. The screw thread may be an inner screw thread and/or an outer screw thread. The pressing element is thus attachable or fixable to the body by means of a screwed connection.

The screwed connection can be implemented, loosened and re-tightened in a particularly simple and versatile manner, and the pressing force can also be adjusted in a continuous and very precise manner over the angle of rotation.

The pressing element and/or the pressing counter-element connected rotatably to the pressing element can be turned to adjust the screwed connection.

In a further embodiment the contact surface is surrounded by an at least partially peripheral edge and the pressing element is screwed to the edge. The light source carrier can thus be pressed by the pressing element against an outer lateral edge region so that an upwards bending of the light source carrier is avoided. A large inner area also remains for positioning and forming of the light source carrier and the elements arranged thereon. The pressing element preferably has a screw thread on its lateral outer surface.

In a specific embodiment the pressing element is substantially annular. A particularly narrow pressing element is thus obtained which takes up less space. The pressing element preferably has a screw thread on its peripheral surface (the lateral outer surface).

Alternatively, the pressing element may have a downwardly oriented annular screw protrusion which can be screwed into a matching annular groove provided either in or beside the contact surface.

In another embodiment the body comprises a recess and a through-opening from the recess to the contact surface. Electrical connections, etc. can thus be guided directly from the recess to the printed circuit board. A cable feed element, for example a cable duct, can be inserted into the through-opening. The cable feed element may protrude from the contact surface and be screwed there to the pressing element. The cable feed element consequently comprises a screw thread, at least on its outer face protruding beyond the contact surface. The cable feed element may correspond to a pin provided with a thread, whereas the pressing element acts as a nut.

Owing to the use of the cable feed element, a particularly simple pressing counter-element may be used without having to machine the body itself.

The recess may in particular be formed and/or provided as a driver cavity for receiving a driver for the light sources. The recess advantageously has an insertion opening for the introduction of the driver, for example a driver printed circuit board. The insertion opening of the recess may advantageously be located on a rear face of the heat sink. The insertion opening and the cable feed element are advantageously located on opposite sides of the recess. For example, the recess may be cylindrical. The recess may advantageously be electrically insulated from the heat sink so as to avoid direct leakage paths, for example by means of an electrically insulating coating (also called a driver cavity housing or DCG), for example in the form of a plastics material tube inserted into the recess through the insertion opening. The coating may comprise one or more attachment elements for attachment of the driver.

The cable feed element is used to feed or pass through at least one electrical line between the driver located in the recess and the at least one semiconductor source and the carrier fitted thereto. The cable feed element and the coating may be formed in one piece as a single element. The cable feed element is then also pushed through a through-opening in the heat sink simultaneously with the insertion of the coating into the recess.

The at least one electrical line, which may be formed for example as a wire, a cable or a connector of any type, can be contacted by means of any suitable method, for example by means of soldering, resistance welding, laser welding, etc.

The driver may be a general control circuit for controlling the at least one semiconductor source. The driver is preferably designed as a non-SELV driver, in particular as a non-SELV driver having no transformer. A non-SELV driver has a greater efficiency of typically more than 90% compared to a SELV driver and can also be produced in a more cost effective manner. No safety spacings are required in the driver between the primary side and the secondary side, as is a prerequisite in a SELV driver with use of a transformer. Instead, a separation between the primary side and secondary side takes place primarily between the carrier and heat sink. With a non-SELV driver having no transformer the transformer may advantageously be replaced by a coil or a buck configuration/step-down converter.

The pressing element may be provided as a separately produced element which can be fitted on the lighting device.

In an alternative or additional embodiment the pressing element corresponds to the carrier. In other words, the pressing element is integrated in the carrier or the carrier includes the function of the pressing element. The carrier itself is thus attachable to the body by means of the rotary motion and thus itself presses against the contact surface. For this purpose, the light source carrier, for example the printed circuit board, as such may have a screw thread. Such a light source carrier can be applied to the embodiments already described above.

The light source carrier may thus have at least one screw thread on its outer surface (outer peripheral surface) and can thus be screwed, for example directly, into the edge of the contact surface. As the angle of rotation increases, the light source carrier is lowered continuously onto the contact surface and, can be pressed on with a defined pressure. Separate screw elements may be omitted or used in addition for a more uniform or stronger pressing force.

Alternatively, the light source carrier may have an inner, in particular central opening which is equipped with a screw thread for screwing onto the above-described cable feed element. The light source carrier may be rotated into the cable feed element. However, for fault-free positioning and for adjustment of a precise pressing force, it is advantageous if the light source carrier remains stationary and if the cable feed element is rotated.

In a specific embodiment the carrier is a metal core printed circuit board. This affords the advantage that the metal core provides a material which is suitable for incorporation of a stable thread.

In an alternative or additional embodiment the carrier comprises a metallised screw thread. The metallisation may also be applied to a conventional printed circuit board material in which a screw thread is formed, for example a copper metallisation on a FR4 base material.

In a further embodiment the pressing element is screwed into the through-opening and is screwed directly to the through-opening, that is to say the body, or to an insert located in the through-opening, for example a plastics material ring or a plastics material sleeve. The through-opening may consequently be formed as a (possibly metallised) screw bore, and the pressing element may be formed in a screw-like manner with a laterally protruding screw head and possibly provided with an elongate bore. The pressing element may be screwed into the through-opening from the outside and, via its screw head, may thus press the carrier against the contact surface. For example, cables, wires, etc. can be guided from the recess to the light source carrier through the cable duct formed as an elongate bore in the pressing element. Alternatively, the through-opening may be provided with an insert which has a screw bore for screwing in the pressing element.

In an additional embodiment the carrier comprises a carrier opening arranged substantially concentrically with the through-opening. The cable feed element protruding from the through-opening or the pressing element screwed into the through-opening or insert therein can thus be used as a centering aid.

In yet another embodiment the pressing element is attachable to the body by means of a plug-and-twist motion, in particular by means of a bayonet connection. A plug-and-twist connection affords the advantage that it provides protection against overtightening. For example, the pressing element can be equipped, either as a separate component or as a function of the printed circuit board, with knob-like protrusions which insert into corresponding sockets or grooves in the body and can be twisted in the manner of a bayonet catch. The grooves are preferably formed in the edge of the contact surface.

In principle it is also possible to use a plurality of twisting/pressing elements, for example a central twist-and press element and a lateral, external twisting/pressing element.

In a further embodiment the lighting device also comprises at least one latching/pressing element for pressing the carrier onto the body, wherein the latching/pressing element can be attached to the body by means of a latching process. A further pressing element of a different type may also be used in addition to a twisting/pressing element. In this case, too, the tolerance compensation may be produced by a rotary motion, which for example avoids a curvature (banana effect). The planar pressing force is distributed over two elements and therefore over further distributed force transmission points or surfaces.

In a specific embodiment the latching/pressing element is annular and surrounds the carrier at a lateral or peripheral edge region and presses it against the contact surface.

In a further embodiment the pressing element (latching/pressing or twisting/pressing element) is a carrier for a covering element which is light-permeable for example.

In a specific embodiment the covering element comprises at least one recess for at least one light source or parts thereof. The recess may thus be provided above a lens of the LED so as not to influence a beam guidance of the LED. However, the whole LED, for example including the housing thereof, may also remain obscured from view.

The covering element may be formed in one piece with the pressing element, that is to say as an integral element. The covering may thus comprise latching hooks at its edge. To press the carrier, the covering element may also comprise a protrusion which is directed downwardly onto the carrier and which for example is peripheral, either completely or in part, and acts as a holding-down device.

Generally, the cable feed element may also be arranged excentrically, for example offset laterally from the longitudinal axis of the heat sink or the substrate. The cable feed element may also be arranged outside a lateral extension of the carrier. The at least one electrical line can then be guided to the carrier, laterally from the outside.

It may generally be preferred if a leakage path is at least 1 mm long, more preferably at least 6.5 mm long. The air gap is preferably at least 4 mm.

An at least local heat conductivity or heat spread of the carrier may advantageously lie between 20 (W/m·K) and 400 (W/m·K), for example approximately 400 (W/m·K) for a copper layer.

The semiconductor light source may advantageously be fed by means of a non-SELV voltage, however use with a safety extra low voltage (SELV) is also possible.

The driver may be a non-SELV driver having no transformer.

The lighting device may particularly advantageously be formed as a retrofit lamp, in particular an LED retrofit lamp, or as a module therefor.

The object is also achieved by a method for producing a lighting device, wherein the lighting device comprises at least one body having a contact surface for a light source carrier, wherein the light source carrier is pressed onto the contact surface by screwing a pressing element onto the lighting device.

In a development the screwing-on is continued up to a threshold value, for example up to a predefined torque.

The invention will be described schematically in greater detail in the following figures on the basis of embodiments. Like or functionally like elements may be provided with like reference numerals for improved clarity.

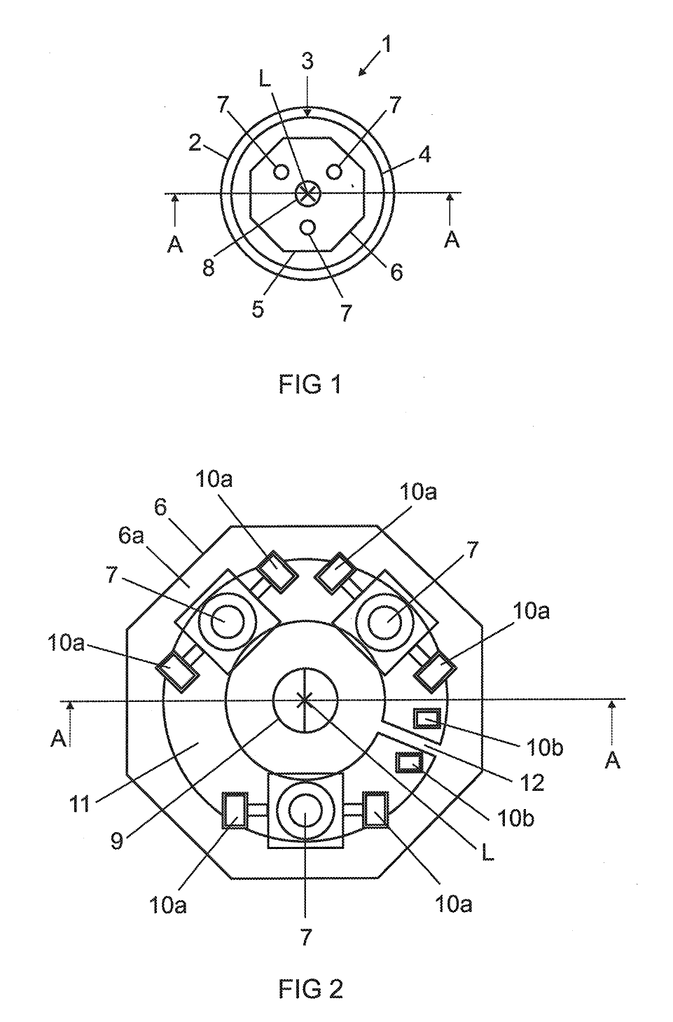

FIG. 1 is a plan view of a first embodiment of an LED retrofit lamp having a fitted carrier;

FIG. 2 is a detailed plan view of the carrier from FIG. 1;

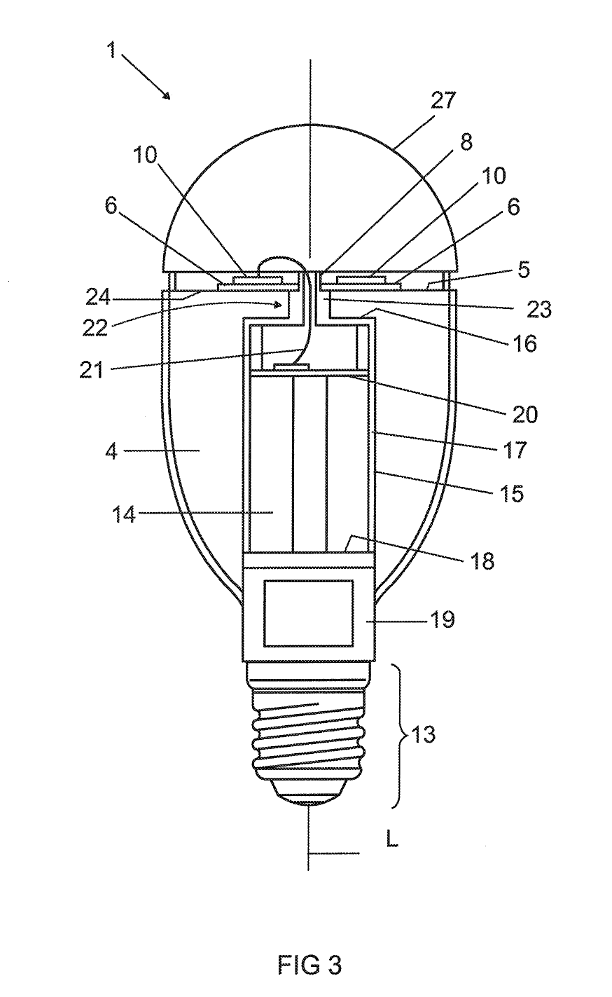

FIG. 3 is a lateral sectional view along the sectional line A-A from FIG. 1 of the first embodiment of the LED retrofit lamp;

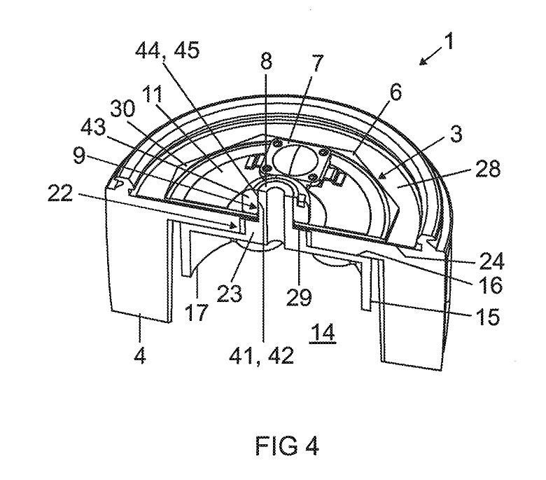

FIG. 4 is an oblique view of a detailed portion from the sectional view of the first embodiment of the LED retrofit lamp;

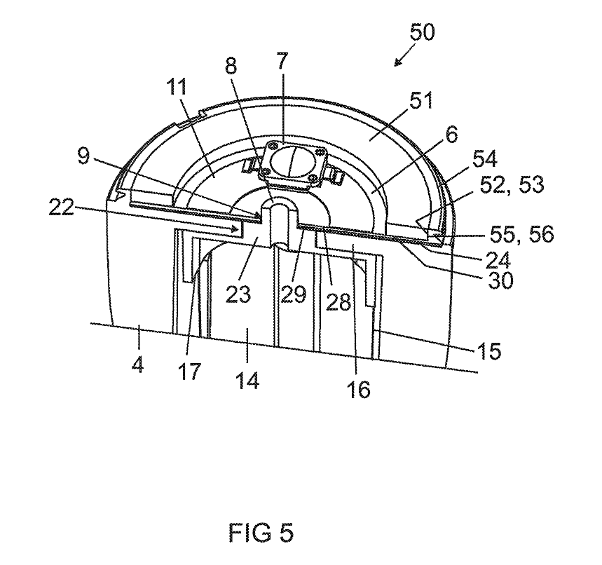

FIG. 5 shows a detail of a second embodiment of an LED retrofit lamp in a view similar to FIG. 4;

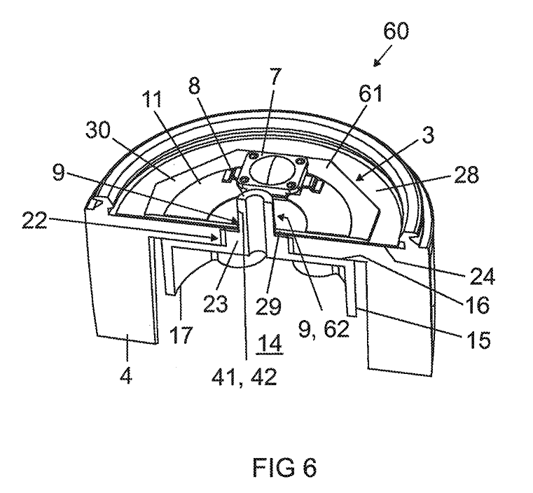

FIG. 6 shows a detail of a third embodiment of an LED retrofit lamp in a view similar to FIG. 4;

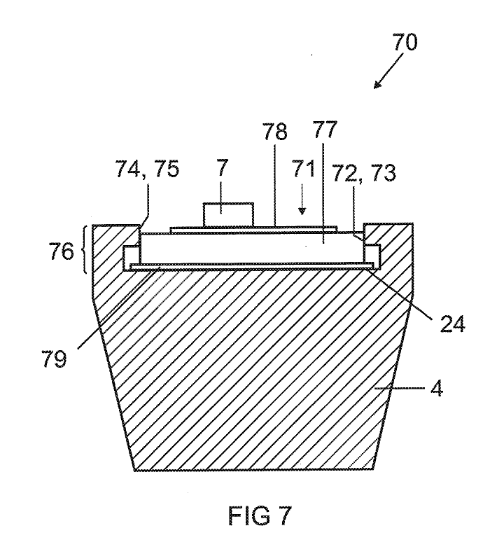

FIG. 7 is a schematic lateral sectional view of a fourth embodiment of a lighting device;

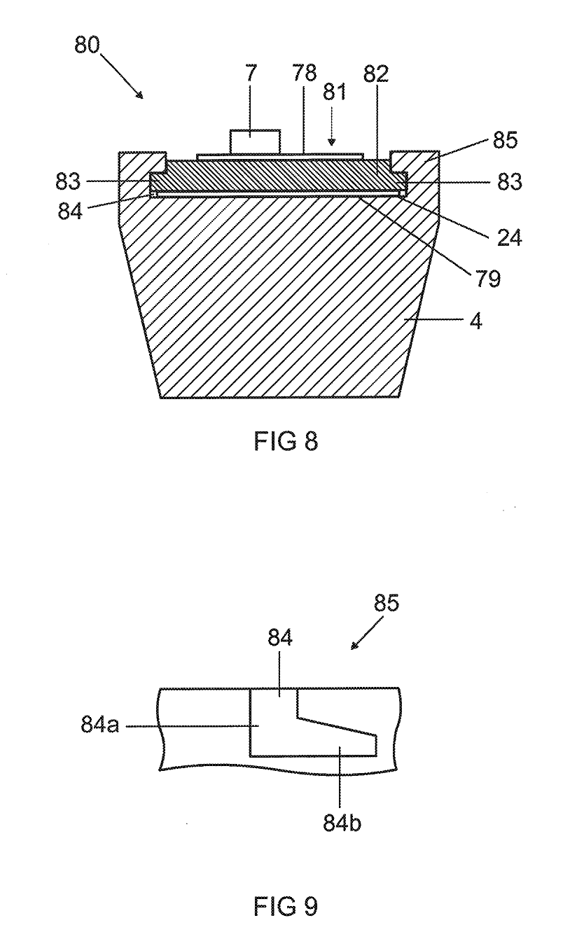

FIG. 8 is a schematic lateral sectional view of a fifth embodiment of a lighting device;

FIG. 9 is a schematic front view of a detail of an edge of the lighting device according to the fifth embodiment;

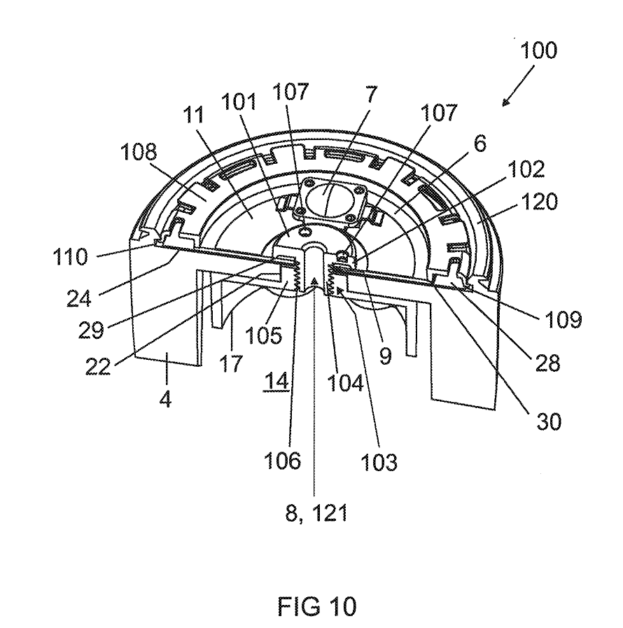

FIG. 10 shows a detail of a sixth embodiment of an LED retrofit lamp in a view similar to FIG. 4;

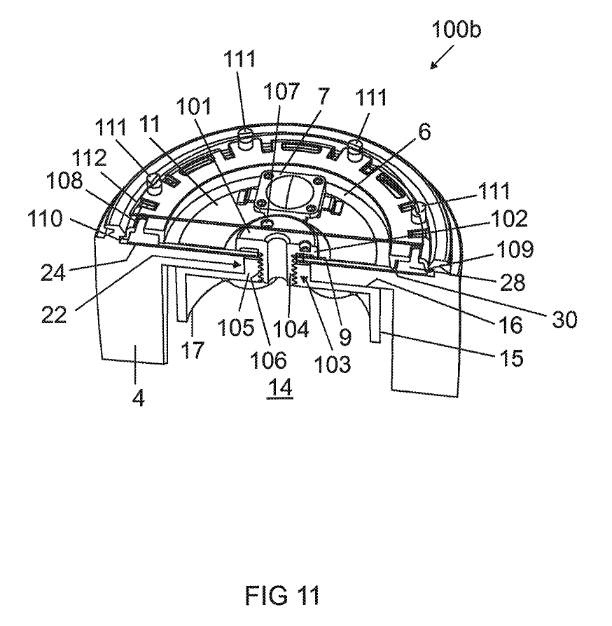

FIG. 11 shows a detail of a seventh embodiment of an LED retrofit lamp in a view similar to FIG. 4;

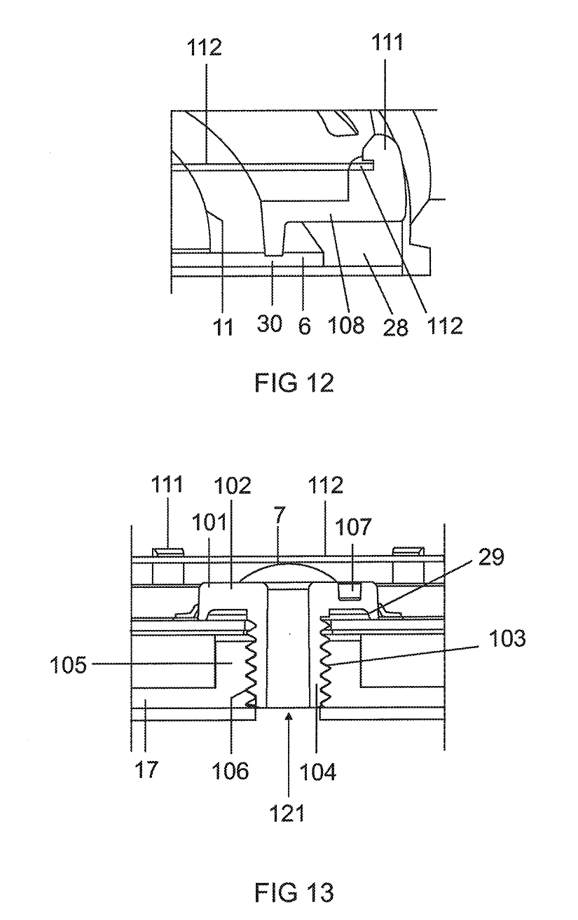

FIG. 12 shows an oblique sectional view of an enlarged detail showing a portion of the lighting device according to the seventh embodiment in the region of a latching/pressing element;

FIG. 13 shows a lateral sectional view of an enlarged detail of the lighting device according to the seventh embodiment in the region of a screwing/pressing element;

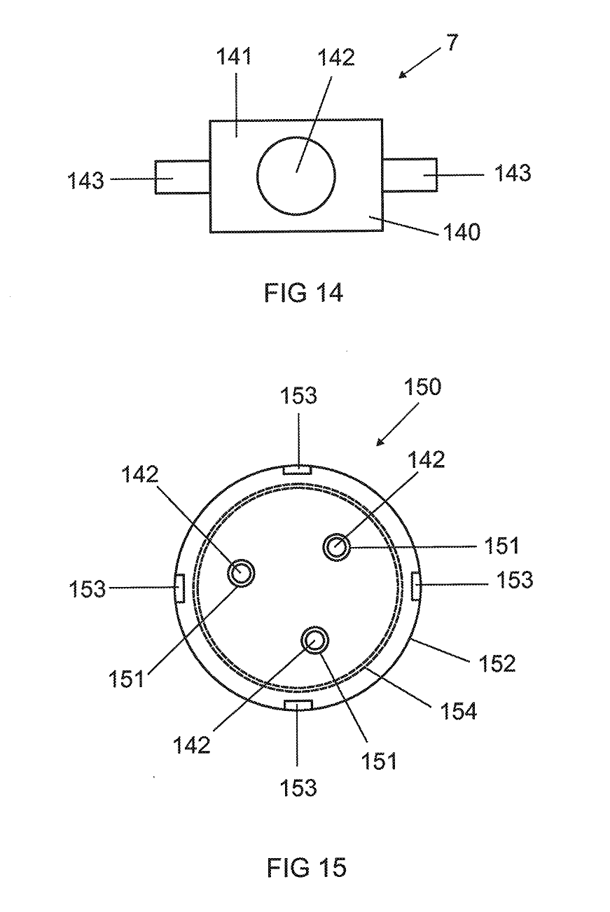

FIG. 14 is a plan view of an LED of one of the LED retrofit lamps;

FIG. 15 is a plan view of a covering element for use with the lighting device according to the seventh embodiment;

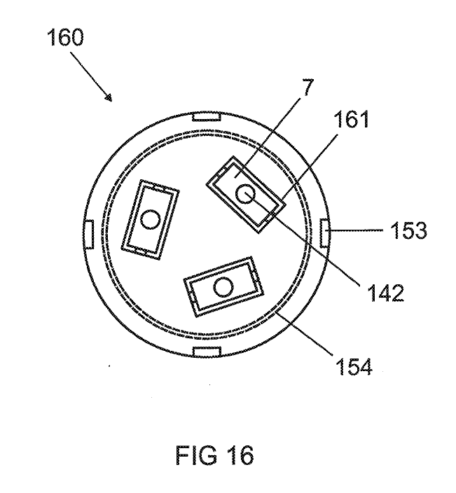

FIG. 16 is a plan view of a further covering element for use with the lighting device according to the seventh embodiment.

FIG. 1 shows a plan view of an LED retrofit lamp 1 according to a first embodiment. The LED retrofit lamp 1 is used in this case to replace a conventional incandescent lamp having an Edison cap and thus has an outer contour which roughly reflects the contour of the conventional incandescent lamp, at least in its basic shape (see FIG. 3 also). The LED retrofit lamp 1 comprises an outer sleeve 2, into which an LED module 3 is inserted. The LED module 3 comprises an aluminium heat sink 4, to the upper face or front face 5 of which shown in this instance an Al₂O₃ carrier 6 with an octagonal outer contour is attached. The carrier 6 is equipped with light sources in the form of LEDs 7. The LEDs 7 illuminate into the upper semi-circle, that is to say in this illustration with a primary beam direction beyond the image plane. The carrier 6 has a central hole, via which the carrier 6 can be plugged tightly over a cable feed element formed in this instance as a cable duct 8. The cable duct 8 acts as an element for passing through electrical lines (not shown) from a driver (not shown) located in the heat sink 4 to the carrier 6. The carrier 6 and the cable duct 8 are thus positioned coaxially in relation to a longitudinal axis L of the lighting device 1 extending perpendicular from the axis of the image, wherein the longitudinal axis L extends centrally through the cable duct 8.

FIG. 2 shows a detailed plan view of the carrier 6 from FIG. 1. A front face 6a of the carrier 6 is equipped with three white LEDs 7 which are arranged approximately angle symmetrically about the longitudinal axis L, wherein the longitudinal axis L extends centrally through the hole 9 in the carrier 6. The LEDs 7 are electrically contactable, for the power supply thereof, to the carrier 6 by means of contact surfaces 10a. For power supply, electrical lines (not shown) are guided from the driver, through the cable duct to the cable connection surfaces 10b. The electrical conductors used to carry current are formed by a correspondingly structured (shown here in a largely simplified manner) external cooper layer 11. The contact faces 10a as well as the cable connection faces 10b and the cooper layer 11 are potential-carrying surface areas which are electrically insulated, at least by means of the carrier 6, from the heat sink 4 over sufficiently long insulation paths. The copper layer 11 is not completely peripheral, but is interrupted by the LEDs and has a gap 12 extending radially in relation to the longitudinal axis L to avoid a short circuit.

FIG. 3 shows a first embodiment of the LED retrofit lamp 1 in the form of a sectional view along the sectional line A-A from FIG. 1. The LED retrofit lamp 1 does not protrude beyond the outer contour of a conventional incandescent lamp and can be used with its Edison cap 13 as a replacement for a corresponding incandescent lamp. A cylindrical recess in the form of a driver cavity 14 is provided in the heat sink 4 and is coated over its lateral peripheral surface 15 and upper end face 16 with an electrically insulating coating 17 (also referred to hereinafter as a “driver cavity housing” or DCH) made of a plastics material. A lower insertion opening 18 is sealed in an electrically insulating manner from the heat sink 4 by an attachment 19 which also includes the Edison cap 13. A driver circuit board 20 is received in the driver cavity 14 and the coating 17 and comprises all or at least some of the elements required for operation of the LEDs 7. The printed circuit board 20 is thus connected electrically to the Edison cap 13 for power supply and forwards to the LEDs 7 the voltage and/or current required to operate the LEDs 7 via an electrical cable 21. For this purpose the printed circuit board 20 is connected via the electrical cable 21 to suitable cable connection surfaces 10b. The driver implemented on the printed circuit board 20 is a non-SELV driver having no transformer in this instance. A separation between the primary side and secondary side takes place primarily between the carrier 6 and the heat sink 4. The non-SELV driver having no transformer may comprise a coil or buck configuration/step-down converter for voltage conversion.

To pass the cable 21 through the upper end face 16, the upper end face 16 has a through-opening 22. To electrically insulate the printed circuit board 20 from the heat sink 4, the coating is formed in such a way that the cable duct 8, which connects the driver cavity 14 or the interior of the coating 17 to the front face 5 of the heat sink 4, is integrated integrally in the coating 17. The front face 5 is covered by an opaque and light-scattering envelope 27 for protection and to homogenise the light irradiated by the lighting device 1. For example, the envelope 27 may be clamped to the heat sink 4.

FIG. 4 shows an oblique view of a detailed section from the sectional view of the LED retrofit lamp 1. The cable duct 8, which protrudes upwardly beyond the contact surface 24 and which forms part of the coating 17, projects through the central hole 9 in the carrier 6 and comprises a screw thread 42, at least on part of its protruding outer face 41. The cable duct 8 is screwed externally to a pressing element 43 which comprises a thread 45 on its inner face or inner peripheral surface 44 matching the screw thread 42. The pressing element 43 leaves the cable duct 8 open.

In an exemplary assembly process, the coating 17 is first inserted into the driver cavity 14 in such a way that the associated cable duct 8 is pushed through the through-opening 22 and thus protrudes out from and beyond the contact surface 24 upwardly and outwardly. The interface layer 28, which has a central hole, is then placed on the contact surface 24 so that it is arranged with only a small clearance or at only a short distance from the cable duct 8. The cable duct 8 thus acts as a centering aid for supporting the interface layer 28. The carrier 6, which is already provided with electrical conductors and is equipped with LEDs 7, is then placed on the transition layer 28. In this case the hole 9 in the carrier 6 is placed on the cable duct 8 so that the cable duct 8 also acts as a centering aid for the carrier 6.

The pressing element 43 is then placed on the cable duct 8 and screwed to the cable duct 8 by a corresponding rotary motion. The pressing element 43 thus presses the carrier 6 via its inner edge 29 onto the interface layer in a perpendicular manner and therefore onto the contact surface 24; the edge 29 thus constitutes a force transmission area and requires only a small amount of space. The pressing element 43 is turned or screwed until a predefined torque threshold value is reached which constitutes a measure for the pressing force. The sequence described can be carried out automatically, either completely or in part.

The present embodiment affords the advantages that the spatial requirement for the pressing element 43 is low and a compact design is enabled, that such a device can be assembled easily and quickly (possibly in an automated manner), and that a tolerance compensation can thus be provided in a simple manner.

FIG. 5 shows a second embodiment of a lighting device 50, in which the pressing element 51 now presses the carrier 6 at its outer edge 30 onto the interface layer 28 and the contact surface 24. For this purpose, the pressing element 51 is formed annularly in this instance and has a screw thread 53 at its lateral edge or over its outer peripheral surface 52. A peripheral edge 54 which projects upwardly from the contact surface 24, surrounds the contact surface 24, and has a thread 56 on its inner face 55 matching the thread 53 is used as a pressing counter-element.

For assembly, the pressing element 51 can be rested against the inner face 55 of the edge 54 and screwed to the edge 54 by a rotary motion. In this case, too, a pressing force may be defined, for example by a measurement or observance of a torque. The cable duct 8 also protrudes beyond the contact surface 24 and acts as a centering aid for the interface layer 28 and the carrier 6, but does not have a thread or the like.

It is also possible to combine the features of the first and second embodiments and to thus obtain a lighting device for example which comprises both a pressing element 43 screwed to the cable duct 8 and a pressing element 51 screwed to the edge 54. Such a design affords the advantage that a pressing force distributed uniformly over the carrier 6 is applied. This may be expedient, in particular, for thin carriers 6.

FIG. 6 shows a third embodiment of a lighting device 60, in which the carrier 61 now also serves as a pressing element, that is to say the carrier 61 is an automatically pressing element. In the embodiment shown, the cable duct 8 has a screw thread 42 on its outer side or outer face 41 which is similar to the first embodiment. At the same time, the central hole 9 in the carrier 61 has a matching screw 62. To provide a sufficiently stable thread 62 of the carrier 61, the carrier 61 is preferably designed as a metal core printed circuit board, wherein the thread 62 is formed in the metal core. Owing to the typically short height of the metal core, the thread 62 only has to have a few turns, possibly even only one thread turn or only part of a thread turn.

Alternatively to the metal core printed circuit board, a printed circuit board having a non-metal base material, for example FR4, may also be used for example, wherein the thread formed therein may preferably be metallised for mechanical stability and to increase abrasion resistance.

In principle, it is possible to form the screw connection in such a way that the carrier 61 is unscrewed onto the stationary cable duct 8. However, for precise positioning and to avoid damage to the interface layer 28, it is preferable if the carrier 61 is fitted on the interface layer 28 and remains stationary thereafter. The screw connection may then be produced by turning the cable duct 8 or the coating 17, that is to say the cable duct 8 is screwed into the carrier 61 serving as a nut in a screw-like manner.

FIG. 7 shows a rather enlarged lateral sectional view of a lighting device 70 according to a fourth embodiment, in which the carrier 71 is integrated with the pressing element, wherein the carrier 71 has a screw thread 73 on its peripheral outer face 72. This screw thread 73 is provided to be screwed with a thread 74 on an inner face 75 of an edge 76 of the heat sink 4 arranged peripherally around the contact surface 24.

In this case, too, it is advantageous if the carrier 71 is a metal core printed circuit board, since the outer thread 73 can then be inserted comparatively easily into the metal copper layer 77 of the carrier. The carrier 71 has an upper dielectric layer 78 on its upper face for electrical insulation from the LED 7, and a lower dielectric layer 79 for insulation from the heat sink.

This embodiment affords the advantage that it is suitable for setting a tolerance compensation and also does not require any additional parts, such as separate pressing elements.

FIG. 8 shows a fifth embodiment of a lighting device 80, in which the carrier 81 is designed for attachment in accordance with the bayonet principle, wherein the carrier 81 is again an automatically pressing element. For this purpose, the carrier 81 is formed as a metal core printed circuit board to provide a high level of stability, the planar copper core 82 of which has knobs 83 protruding laterally at two opposite points. The knobs 83 may be inserted into respective slits 84 which are formed in the lateral edge 85 of the heat sink 4. The lateral edge 85 surrounds the contact surface 24 for the carrier 81 peripherally, at least over portions.

FIG. 9 shows a detail of the edge 85 in the region of the slit 84 for receiving the knobs 83 of the carrier 81. To insert the carrier 81, a respective knob 83 thereof is first inserted or plugged into a longitudinal slit section 84a from above and then rotated. As a result of the rotary motion, the knobs 83 move into a transverse slit section 84b of the respective slit 84. The transverse slit section 84b is illustrated in this instance as a slit tapering from the longitudinal slit section 84a so that, as the carrier 81 is progressively rotated, the respective knob 83 is clamped in the transverse slit section 84b and is thus fitted in a rigid manner.

Such a plug-and-twist motion affords the advantage that the associated mechanical components (knobs 83/slits 84, etc.) may be formed comparatively approximately, which simplifies production and assembly, even in challenging conditions. For example, the bayonet connection also does not require any additional pressing parts.

FIG. 10 shows a sixth embodiment of a lighting device 100, in which the pressing element 101 is now equipped as a screw-like element having a laterally extending screw head 102 and a pin-like area 104 provided with an outer thread 103. The pressing element may be screwed, similarly to a screw, through the hole 9 in the carrier 6 and through a corresponding central hole in the interface layer 28, into the through-opening 22, more specifically into an insert 105 inserted into the through-opening 22. The insert 105 is part of the coating 17, in which for example in contrast to the first embodiment, the part protruding upwardly from the contact surface 24 is missing. The insert 105 is equipped with an inner thread 106, into which the pressing element 101 can be screwed via its thread. The pressing element 101 has plug-in holes 107 on its upper face as points of engagement for the rotation or screwing of said pressing element. The cable duct 8 is formed by means of a slot 121 formed longitudinally in the pressing element 101.

In addition to the screw connection, the lighting device 100 has a latching connection which is formed by a pressing element in the form of a snap-in ring 108 arranged on the outer edge 30 and connected to the edge. The snap-in ring 108 is snapped into a peripheral groove 110 formed in the inner face of the peripheral edge 120 of the heat sink 4 via a plurality of latching hooks 109. The snap-in ring 108 thus presses the carrier 6, at the outer edge 30 thereof in the form of a force transmission surface, against the contact surface 24. Such a combination of screw connection and snap-in connection affords the advantage that a defined pressing force can be applied by the screw connection, whereas a particularly cost-effective and lightweight transmission of force onto the carrier 6 is provided by the snap-in connection, whereby a relatively uniform pressing force is produced on the whole.

FIG. 11 shows an oblique view of a seventh embodiment of a lighting device 100b, similar to the sixth embodiment. FIG. 12 shows an enlarged view of the lighting device 100b in the region of a latching hook 111. FIG. 13 shows a lateral sectional view of the lighting device 100b in the region of the pressing element 101. Compared to the sixth embodiment of the lighting device 100, the edge-side, annular snap-in ring 108 of the lighting device 100b is now equipped on the upper face with latching hooks 111 for attaching a light-permeable (opaque or transparent) covering disc 112. The covering disc 112 extends just above the LED 7. The covering disc 112 is shown as a simple light-permeable plate in this instance, but may also be formed differently, for example with another basic shape or with an optical function.

Alternatively, the covering disc 112 may also be provided with recesses for the LED 7 and may be lower than shown in FIGS. 11 to 13 so that the LEDs 7 reach through the covering disc 112.

FIG. 14 shows a plan view of the LED 7 of one of the LED retrofit lamps. The LED has a housing 140, on the upper face 141 of which a light-emitting surface is located which, for beam guidance, may be covered by a lens 142 and alternatively or additionally by another optical element. The LED 7 is supplied with power via its supply connections 143.

FIG. 15 shows a plan view of a covering element 150 for use, for example, with the lighting device 100b according to the seventh embodiment. The covering element 150 is now formed integrally as a latching/pressing element and, for example, is produced as an injection moulded part. The covering element 150 has three recesses 151 which are introduced into the covering element 150 above the lenses 142 of the LEDs. The lenses 142 reach through the respective recess 151, at least in part, so that the recess does not hinder the beam guidance and the luminous efficacy. At the lateral edge 152, the covering element 150 comprises downwardly oriented latching hooks 153 which, for example, may engage in the latching socket 110. To press the carrier 6, the covering element 150 also comprises a circular protrusion 154 in the direction of the carrier, that is to say generally oriented downwardly, which protrusion is placed pressingly against the carrier 6 and thus acts as a holding-down device. In this case the covering element 150 does not have to be light-permeable, which affords the advantage that it is not possible to see the underlying element. The covering element 150 is preferably formed as a plastics material disc having a flame retardance rating UL94-V1 or better.

FIG. 16 shows a plan view of a further covering element 160 for use for example with the lighting device 100b according to the seventh embodiment. In contrast to the covering element 150, the recesses 161 are now sized and shaped so that the LED 7 is basically completely recessed. For example, the housing 140 may also reach through the recess 161. Such a design may, for example, improve heat dissipation from the LED 7.

Of course, the present invention is not limited to the embodiments shown.

It may generally also be preferable for the length of the leakage paths to be at least 1 mm, more preferably at least 5 mm.

The material of the heat sink may also comprise, in addition to pure aluminium, an aluminium alloy or another metal or alloy thereof, or an effective heat-conducting plastics material.

Furthermore, the cable duct may also be arranged excentrically (offset laterally to the longitudinal axis). The cable feed element may generally be formed as a separate component or, for example, may be integrated in the coating of the recess and/or in the heat sink, for example integrally.

Generally, the pressing element and the cable duct or the coating may advantageously be produced from a polymer material. A use of electrically noon-conductive materials for the attachment element(s) means that there is no reduction in air gaps or leakage paths.

The interface layer may preferably be produced from a thermal interface material (TIM) or from silicone, etc.

The contact surface may advantageously have a diameter between 20 mm and 30 mm, whereas the carrier may preferably have a diameter between 15 mm and 25 mm.

For example, the carrier may be between 0.16 mm and 1 mm thick, whereas the interface layer may preferably be between 0.15 mm and 0.3 mm thick.

The rotary connections (screw connections, bayonet connection, etc.) may generally be secured against release by a cohesive joint, for example by a use of a screw locking adhesive. Alternatively or additionally, the rotary connections may be self-locking, for example by suitable surface structures or geometrical structures.

The outer contour of the carrier is not restricted and may be round or angular for example.

The lighting device may also generally comprise optical elements such as reflectors, lenses (made of glass or plastics material), etc.

The thread geometry may be formed by any suitable method, for example by casting, pressing, injection moulding, rolling or a removing, for example cutting machining process.

The latching geometry may be secured against release by releasing and joining angles.

The lamp is also not limited to a specific type of cap. In addition to an Edison cap (for example E14, E27), other caps such as GU10 or standard Japanese or American caps may thus also be used.

### LIST OF REFERENCE NUMERALS

1 LED retrofit lamp
2 sleeve
3 LED module
4 heat sink
5 front face
6 carrier
6a front face
7 LED
8 cable duct
9 hole in the carrier
10 contact surface
10a contact surface
10b cable connection surface
11 copper layer
12 gap
13 Edison cap
14 driver cavity
15 peripheral surface
16 upper end face
17 coating
18 insertion opening
19 attachment
20 driver printed circuit board
21 cable
22 through-opening
23 radially extended region
24 contact surface
25 protrusion
26 step
27 envelope
28 interface layer
29 inner edge of the carrier
30 outer edge of the carrier
40 lighting device
41 outer face
42 screw thread
43 pressing element
44 inner face or inner peripheral surface
45 thread
50 lighting device
51 pressing element
52 outer peripheral surface
53 screw thread
54 edge
55 inner face
56 thread
60 lighting device
61 carrier
62 thread
70 lighting device
71 carrier
72 outer face
73 screw thread/outer thread
74 thread
75 inner face
76 edge
77 copper layer
78 upper dielectric layer
79 lower dielectric layer
80 lighting device
81 carrier
82 copper core
83 knob
84 slit
84a longitudinal slit section
84b transverse slit section
85 (lateral) edge
100 lighting device
101 pressing element
102 screw head
103 outer thread
104 pin-like region
105 insert
106 inner thread
107 insertion hole
108 snap-in ring
109 protrusion
110 lighting device
111 latching hook
112 covering disc
120 edge
121 slot
L longitudinal axis

1. A lighting device comprising:
a body having an outer contact surface; and
a light source carrier pressed onto the contact surface by at least one pressing element,
wherein the pressing element is adapted to be attached to the lighting device by at least one rotary motion.

2. The lighting device according to claim 1, wherein the pressing element has at least one screw thread for attachment to the lighting device.

3. The lighting device according to claim 2, wherein the contact surface is surrounded by an at least partially peripheral edge and the pressing element is screwed to the edge.

4. The lighting device according to claim 2, wherein the pressing element is annular.

5. The lighting device according to claim 2, wherein the body comprises a recess and a through-opening from the recess to the contact surface, and a cable feed element is inserted into the through-opening, the cable feed element protruding from the contact surface and being screwed there to the pressing element.

6. The lighting device according to claim 3, wherein the pressing element corresponds to the carrier.

7. The lighting device according to claim 6, wherein the carrier comprises a metal core printed circuit board or a metallised screw thread.

8. The lighting device according to claim 2, wherein the pressing element is screwed into the through-opening.

9. The lighting device according to claim 1, wherein the carrier comprises a carrier opening arranged substantially concentrically with the through-opening.

10. The lighting device according to claim 1, wherein the pressing element is attachable to the lighting device by a plug-and-twist connection.

11. The lighting device according to claim 1, further comprising at least one latching/pressing element (108) for pressing the carrier (6) onto the body (4), wherein the latching/pressing element is attachable to the body by a latching operation.

12. The lighting device according to claim 11, wherein the latching/pressing element is annular and surrounds the carrier and presses it against the contact surface at a peripheral edge region.

13. The lighting device according to claim 1, wherein the pressing element constitutes a carrier for a covering element.

14. The lighting device according to claim 13, wherein the covering element comprises at least one recess for at least one light source or parts thereof.

15. A method for producing a lighting device, wherein the lighting device comprises at least one body having a contact surface for a light source carrier, wherein the light source carrier is pressed onto the contact surface by screwing a pressing element onto the lighting device.

16. The lighting device according to claim 1, wherein said body is a heat sink, and said light source carrier is an LED carrier.

17. The lighting device according to claim 10, wherein said plug-and-twist connection is a bayonet connection.
